(19) United States
(12) Patent Application Publication
(10) Pub. No.: US 2002/0034978 A1
(43) Pub. Date: Mar. 21, 2002

(54) Activity management system

(76) Inventors: John V. Legge, Orange, CA (US); Robert Lasnik, Yorba Linda, CA (US); Gordon E. Gray III, Long Beach, CA (US)

Correspondence Address: Price and Gess, Suite 250, 2100 S.E. Main Street, Irvine, CA, 92614-6238, US

(21) Appl. No.: 09/973,136

(22) Filed: Oct. 9, 2001

Related U.S. Application Data
(63) Continuation-in-part of application No. 09/756,380, filed on Jan. 8, 2001.
(60) Provisional application No. 60/233,347, filed on Sep. 18, 2000.

(51) Int. Cl. A63F 13/00

(52) U.S. Cl. 463/25; 463/1; 463/47

(57) ABSTRACT

The present invention is an activity management system, in particular for access control and monitoring at amusement parks, ski resorts, correctional facilities, hospitals and subway systems. The preferred embodiment of the activity management system comprises a client transponder card with a memory unit, an activity station that can be integrated with an access control device, and a management station. The memory unit of the client transponder card preferably has event criteria such as a debit/credit indicator and a time stamp. The preferred embodiment of the activity station has an inductive transmission system, a memory unit with programs for evaluating the client transponder's event criteria. The preferred embodiment of the management station has a computer with a database and a management station inductive transmission system for reading and writing data to client transponder cards. The management station preferably has a wireless network data connection with the activity station.

This patent application is a Continuation-in-Part of application Ser. No. 09/756,380, filed Jan. 8, 2001. Said parent application, U.S. Ser. No. 09/756,380, claims priority based on provisional patent application U.S. Ser. No. 60/233,347 filed on Sep. 18, 2000. Both U.S. Ser. No. 09/756,380 and U.S. Ser. No. 60/233,347 are fully incorporated herein by reference.

### TECHNICAL FIELD

The present invention is an activity management system, in particular for access control and monitoring at amusement parks, ski resorts, correctional facilities, hospitals and subway systems.

### BACKGROUND ART

Amusement parks and ski resorts are substantial industries. These industries frequently use ticket booths and/or turnstiles to control and monitor access to their facilities, rides and events. These booths and turnstiles can require substantial labor and the accounting, maintenance and security of large sums of coins and other currency. These systems also generally require a user to return to a central location to acquire tickets, tokens, coins or change for bills.

Generally, these systems can be cumbersome, expensive, and limited in application. Furthermore, ticketing booths and turnstiles at amusement parks and resorts generally do not gather valuable data about customers' demographics and other information for marketing, management and other purposes.

Thus, there is a need for an activity management system that facilitates the accounting, maintenance and security of large sums of coins or other currency and that can also facilitate access control and monitoring functions. There is also a need for a system that gathers information about customers at these facilities.

### SUMMARY OF THE INVENTION

The present invention is an activity management system, in particular for access control and monitoring at amusement parks, ski resorts, correctional facilities, hospitals and subway systems. The preferred embodiment of the activity management system comprises a client transponder card with a memory unit, an activity station, a management station, and an attendant transponder with a memory unit. The memory unit of the client transponder card preferably has event criteria such as a debit/credit indicator, a content rating and a time stamp. The memory unit of the attendant transponder preferably has a passkey and a debit/credit indicator. The preferred embodiment of the activity station has an inductive transmission system, a memory unit with programs for evaluating the client transponder's event criteria such as the debit/credit indicator, content rating and/or time stamp and programs for interacting with the attendant transponder's passkey and debit/credit indicator. The preferred embodiment of the activity station also has three status indicating lights and an alphanumeric display. The preferred embodiment of the management station has a computer with a database and a management station inductive transmission system for reading and writing data to client transponder cards. The management station preferably has a wireless network data connection with the activity station via transceivers in each station. The management station periodically queries the activity station for data.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a diagram of a preferred embodiment of the system.

FIG. 2 is a perspective view of a preferred embodiment of a client or attendant transponder card.

FIG. 3 is a perspective view of a preferred embodiment of an activity station.

FIG. 4 is a front view of a preferred embodiment of a management station.

FIG. 5 is a block diagram of a preferred embodiment of an activity station.

FIG. 6 is a front view of a preferred embodiment of a monitoring station.

FIG. 7 is a front view of a preferred embodiment of a till station.

FIG. 8 is a view of an alternative embodiment of the invention installed at an amusement park attraction.

FIG. 9 is a view of an alternative embodiment of the invention installed at a ski lift/ski resort.

FIG. 10 is a view of an alternative embodiment of the invention as used to detect a buried skier.

FIG. 11 is a view of an alternative embodiment of the invention as installed at a healthcare facility cafeteria.

FIG. 12 is a view of an alternative embodiment of the invention as installed at a correctional facility.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an activity management system.

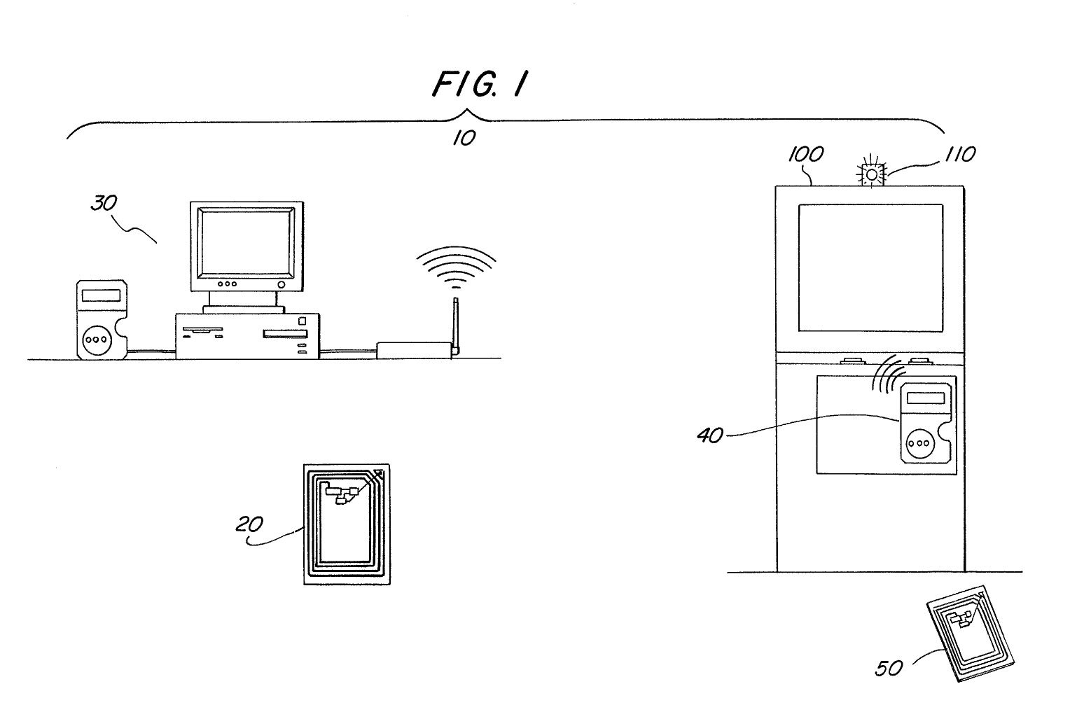

Referring now to FIG. 1, a preferred embodiment of an activity management system 10 is shown comprising a client transponder card 20, a management station 30, and an activity station 40 connected to a coin mechanism of a coin-operated machine 100. The client transponder card 20 is preferably issued from the management station 30. An attendant transponder 50 is also shown.

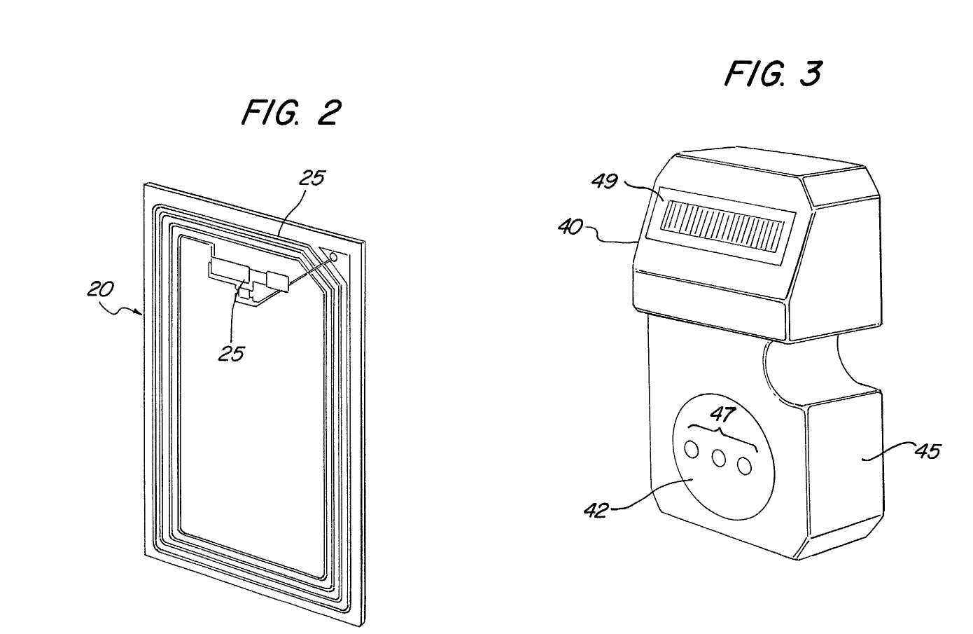

Referring now to FIG. 2, the preferred embodiment of the client transponder card 20 has a memory unit 25 and an antenna 27. Preferably, the client transponder card 20 is a passive, battery-less transponder and the memory unit 25 is a 512-bit non-volatile user memory with read/write capability. The memory unit 25 is programmable and can be locked to protect data from modification. Preferably, the client transponder card 20 is thin, approximately 0.085 mm to 0.355 mm thick. The transponder is placed on a polymer tape substrate. The preferred embodiment of the client transponder card 20 is a Philips I Code 1 RFID IC with a 13.56 Mhz operating frequency. Alternatively, a Texas Instruments' Tag-it™ TIRIS transponder or ISO standard transponder can be used.

The client transponder card 20 is shown uncovered in FIG. 2. The client transponder card 20 can fit between layers of laminated paper or plastic such as stickers, labels, tickets and/or badges. The client transponder card 20 can additionally have magnetic strips, bar codes or other printed information such as optical and/or holographic printing.

The client transponder is shown in its preferred embodiment on a card. However, other shapes and placement are possible due to the relatively small size of the client transponder. For example, the client transponder can be placed on, inter alia, a wand, a key holder, and clothing. The client transponder could also be placed subcutaneously on a customer.

The client transponder 20 has a preferable operating/detection range of 1.5 meters. However, the range is preferably tuned down to 50 millimeters so that inadvertent detections are not generated by other client transponders within range of an activity station 40. As discussed below, this detection range may also be increased for, inter alia, detection and location of individuals.

The memory unit 25 of the client transponder card 20 preferably contains data establishing event criteria including, inter alia, a debit/credit indicator, a content rating, a time stamp, and/or an age and/or height restriction.

The attendant transponder 50 preferably has the same components as the client transponder 20. However, as shown below, the attendant transponder 50 has different data loaded into the memory unit 25.

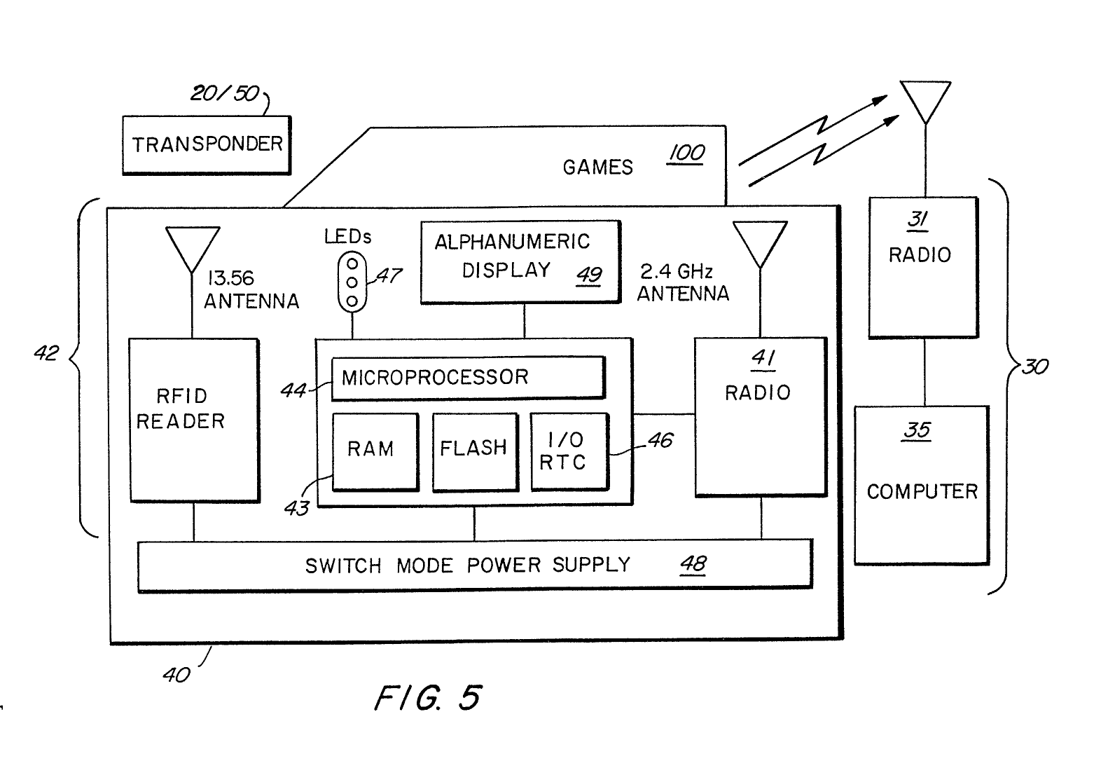

Referring now to FIG. 3, a preferred embodiment of the activity station 40 is shown. The activity station 40 has a casing 45 supporting an inductive transmission system 42, a “traffic light protocol,” i.e. red, yellow, and green, set of status indicating lights 47, and an alphanumeric display 49. The activity station 40 also, preferably, has a transceiver 41, a memory unit 43, a micro-controller 44, a time-keeping chip 46 and a power supply 48. A block diagram of, inter alia, these components for the activity station 40 is shown in FIG. 5.

The preferred embodiment of the inductive transmission system 42 is an OBID i-scan® ID ISCM01-A/B inductive transmission system manufactured by FEIG Electronic GmbH. The inductive transmission system 42 enables contact-less identification of objects including but not limited to the client transponder card 20. The components of the system 42 enable users to write on the client transponder card 20 and to read it. The system 42 can read and write on different transponder types such as a client transponder card 20 and an attendant transponder 50. Preferably, data is encoded and decoded in blocks at the activity station 40 (or the management station 30) in real time, preferably at the inductive transmission system 42. Preferably, the system 42 encrypts some data (such as a unique serial number for each client transponder 20) or all of the data written to the client transponder 20 using the DES encryption system. The data is preferably encrypted with a 16-bit key. This increases the security of transactions/transmissions between a client transponder 20 and an activity station 40 or management station 30. For example, data encryption can impede or prevent the copying of client transponder cards bearing cash and thereby reduce fraud.

The preferred embodiment of the memory unit 43 is a 4 Megabit CMOS 5.0 Volt-only Boot Sector Flash Memory and 4 Mega-bits of static RAM. An AMD® Am29F400B is preferred for the flash memory. The memory unit preferably contains various software programs. The programs control the inductive transmission system 42, evaluate event criteria read from the client transponder card 20, authenticate client transponder cards 20 and attendant transponders 50, perform diagnostic and status checks of the activity station 40 and the activity management system 10, manipulate the debit/credit indicator on the client transponder card 20, and secure stored data with a passkey program. The program functions are identified in the 24 flow charts in U.S. Ser. No. 60/233,347.

The preferred embodiment of the time-keeping chip 46 is a Dallas Semiconductor DS1302 Trickle Charge Timekeeping Chip. The preferred time-keeping chip 46 has a real time clock/calendar and 31 bytes of static RAM. The time-keeping chip 46 communicates with the microcontroller 44 with a simple serial interface. Preferably, the time-keeping chip 46 provides seconds, minutes, hours, day, date, month and year information. The end of the month date is automatically adjusted for months with less than 31 days, including corrections for leap year. The time-keeping chip operates in either the 24-hour or 12-hour format with an AM/PM indicator. The time-keeping chip 46 is also preferably connected to a battery. The battery is useful in maintaining the time-keeping function if and when the activity station 40 loses power.

The preferred embodiment of the alphanumeric display 49 is a 5×7 Dot Character Vacuum Fluorescent Display (“VFD”) manufactured by Noritake Co., Inc. The preferred display 49 has two rows of twenty characters each (2×20), 9 mm high, and can show a variety of letters, numbers, characters and symbols.

The preferred embodiment of the microcontroller 44 is an AMD® Am186™ ES. The microcontroller 44 is connected to and controls the “traffic light protocol” set of status indicating lights 47, the alphanumeric display 49, and the inductive transmission system 42 based on data and instructions from the time-keeping chip 46 and the memory unit 43.

The preferred embodiment of the transceiver 41 is a ZEUS™ Model ZLRT2100 stand-alone transceiver. The preferred transceiver uses Frequency Hopping Spread Spectrum (FHSS) technology for security and reliability of longer range transmissions. The transceiver 41 preferably operates in the 2.4 Ghz frequency band. The transceiver 41 creates a wireless network data connection with a transceiver 31 in the management station 30. The transceiver 41 can use a variety of network protocols to communicate with other transceivers including but not limited to a serial asynchronous protocol using both TTL and RS 232 levels. Other network protocols used in both wireless and wired networks are usable such as TCP/IP and IPX. The transceiver 41 also preferably has error detection and correction algorithms. The preferred range of the transceiver 41 is 1500 feet. However, a set of repeaters can extend the signal range up to four times to 6,000 feet.

A wireless network data connection is preferred but not required. A wired network data connection may be desirable for, inter alia, security reasons or to connect to other pre-existing data networks.

The activity station 40 can be connected to a coin mechanism of a coin-operated machine 100 such as a video arcade game or slot machine. The most common prior art coin mechanism generates a coin pulse of a predetermined pulse width, usually 10-30 milliseconds, to activate the machine 100. The activity station 40 can be adjusted to operate, activate or emulate coin mechanisms that generate a variety of pulse widths.

The activity station 40 can also be connected to an automated ticket dispenser. Automated ticket dispensers are often found in video arcades. The ticket dispenser dispenses tickets for redemption. The tickets can usually be redeemed for various prizes. The activity station 40 can control, dispense and account for tickets from the ticket dispenser.

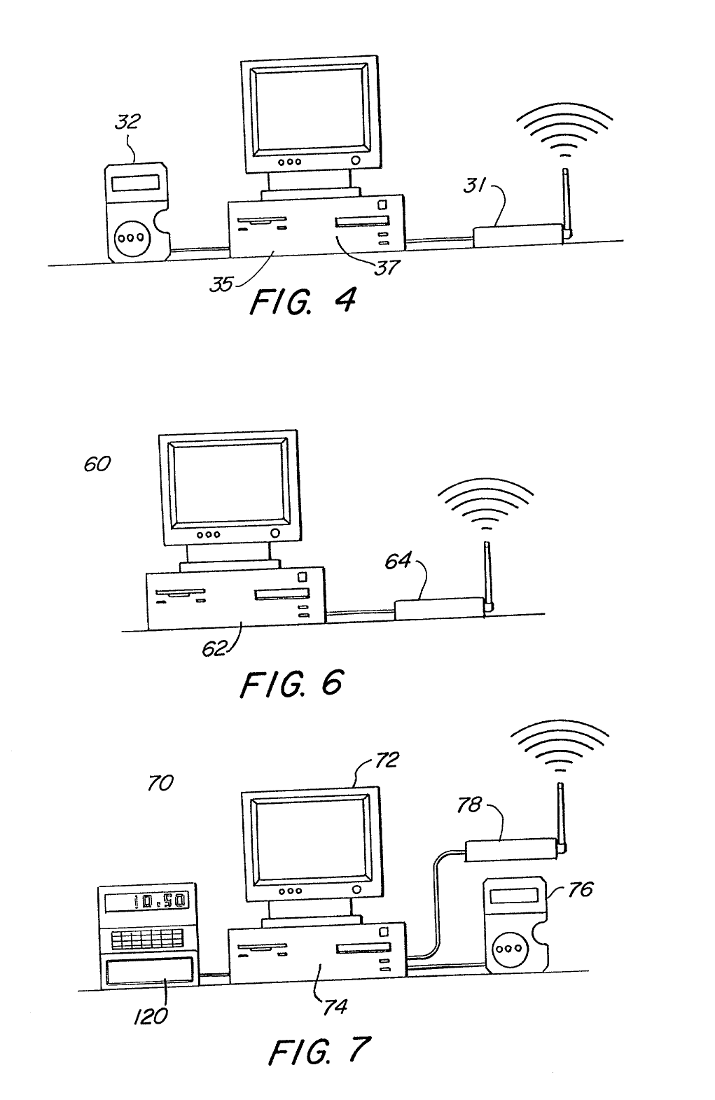

Referring now to FIG. 4, the preferred embodiment of the management station 30 has a computer 35 with a memory and storage unit 37, such as a personal computer. The computer 35 preferably has automatic redemption system software loaded such as ARS 2000™ by Amusement Soft LLC, a database for accounting and management of a plurality of machines 100 and/or activity stations 40. The management station 30 has an inductive transmission system 32 for reading and writing on client transponder cards 20 and attendant transponders 50. The management station 30 also has the transceiver 31 as described above for its wireless network data connection with at least one activity station 40. The management station 30 can preferably control up to 238 activity stations 40 from a central location.

The management station 30 can be separated into two separate stations, a monitoring station 60 and a till station 70. See FIGS. 6 and 7. The monitoring station 60 preferably has a computer 62, preferably a personal computer, and a transceiver 64 to maintain a wireless network data connection with up to 238 activity stations 40 from a central location. The monitoring station 60 monitors each of the activity stations 40 for, inter alia, security and maintenance purposes. The monitoring station 60 also communicates by wired, or wireless connection via the transceiver 64, with the till station 70.

The till station 70 preferably comprises a computer 72 with a memory and storage unit 74, such as a personal computer; and an inductive transmission system 76 for reading and writing client transponder cards 20 and attendant transponders 50. The till station 70 also preferably has a network data connection with the monitoring station 60, either wired or wireless via a transceiver 78. The computer 72 preferably maintains the automatic redemption system software for accounting and management of the plurality of machines 100 and/or activity stations 40. The till station 70 is preferably maintained where currency is collected from customers, client transponders 20 are issued, and accounting of currency and transponders 20 can be input directly into the till station 70. The till station 70 is preferably connected to a cash register 120 or some other type of currency till. These separate stations 60 and 70 may be desirable when extra security is desired for the till station 70 and the currency collected by it.

The activity management system 10 is used as an automated redemption system as follows: A customer obtains a client transponder card 20, preferably from the management station 30. Event criteria are placed on the client transponder card 20 by the management station's inductive transmission system 32. For example, the customer can purchase credits for gaming.

Furthermore, a content rating can be placed on the client transponder card 20 to limit a customer's access to violent, adult or otherwise inappropriate gaming systems in the system 10.

A time stamp can also be used as an event criterion. For example, a special game play rate might be in effect for a pre-determined period of time. (e.g. An introductory 1 hour period of 25 cents vs. 1 dollar per game play.) Also, the time stamp and/or the time-keeping chip 46 can be used to enforce a curfew on minor customers. Alternatively, the time stamp could indicate an expiration date for credits on the client transponder 20, e.g. “This card not usable after Jan. 1, 2002.” The time stamp could also indicate that a client transponder 20 is only usable for a specified period of time from activation (e.g. one hour) on any future date. Age restrictions and height restrictions are also possible event criterion.

Once the management station 30 prepares the client transponder card 20, the customer can take the card 20 to an activity station 40. As stated above, the activity station 40 can be connected to the coin mechanism of a coin-operated machine such as a video game or a slot machine.

The customer waves the client transponder card 20 in front of the inductive transmission system 42 of the activity station 40. If the card 20 is close enough to the system 42, the system 42 will activate the client transponder card 20 and read it. The alphanumeric display 49 and the status lights 47 will indicate to the customer whether the client transponder card 20 has been read. The alphanumeric display 49 can indicate, inter alia, to the customer how many debits/credits are left on the card 20, any event criteria on the card 20, the time, and the cost of game play. The status lights 47, for example, can flash red for a waiting state, yellow to indicate detection of a transponder by the inductive transmission system 42, and green for credits deducted and game and/or machine 100 activated. The status lights 47 are useful for indicating the status of the activity station 40 to customers unable to read the alphanumeric display 49 such as younger customers or customers that do not speak the language displayed.

The activity station 40 will evaluate the event criteria, if any, on the card 20 for restrictions and the number of debits/credits available on the card 20. The customer will then have the opportunity to remove credits from his/her client transponder card 20 to activate the machine 100. If the event criteria permit and the proper credits are available, the activity station 40 will activate the coin mechanism of the machine 100 for game play.

Once game play has begun, a customer can, preferably, remain at the machine 100. If the client transponder card 20 has insufficient credits for continued game play, the customer can notify an attendant verbally or with a call button. Alternatively, an activity station 40 can monitor the number of debits/credits on a client transponder card 20 and if the debits/credits indicator is below a pre-determined level, the management station 30 can be notified to send an attendant to the activity station 40 to ask the customer if he/she wishes to purchase more debits/credits. The attendant will, preferably, have an attendant transponder 50. The attendant can collect money from the customer to purchase more credits. The attendant can also pay out winnings, if any. A customer is, therefore, likely to remain longer at the machine 100.

The attendant transponder 50 can be used in a variety of ways. Preferably, an attendant transponder 50 has a debit/credit indicator in its memory unit 52. The debit/credit indicator is preset at the management station 30 with a pre-determined number of credits when the attendant transponder is issued. The attendant can then collect money in exchange for issuing credits to customers. This allows for a controlled accounting of credits and/or currency.

For example, an attendant can begin with $100 in credits on the attendant transponder 50. If the attendant issues $60 in credits from the attendant transponder 50, when the attendant returns to the management station 30, the attendant will return $60 in currency to the management station and an attendant transponder with $40 in credits.

Alternatively, a three card configuration of the attendant transponder 50 can be used. The three card configuration can have security and accounting benefits. In this embodiment, an attendant carries three attendant transponder cards: a denomination card 55, a cash control card 56, and a supervisor data card 57. The cash control card 56 is used to carry credits just as the attendant transponder 50 is described above. As above, the attendant can begin with a pre-determined number of credits on the cash control card 56.

When the attendant wishes to issue credits to a client transponder 20, the attendant first waves the denomination card 55 in front of the inductive transmission system 42 on the activity station 40. The denomination card 55 indicates how many credits will be removed from the cash control card 56 with each wave. For example, the denomination card 55 can indicate that $1, $5, $10 or $100 should be removed from the cash control card 56 each time the cash control card is waved before the inductive transmission system 42.

Next, the attendant waves the cash control card 56 in front of the inductive transmission system 42 on the activity station 40 to remove credits from the cash control card 56. Finally, the client transponder card 20 is waved in front of the inductive transmission system 42 to write the credits from the cash control card 56 onto the client transponder 20.

The supervisor data card 57 is used to read data from the activity station 40. The supervisor data card 57 can cause the activity station 40 to read out data on the alphanumeric display 49. Alternatively, the activity station 40 can write data collected to the supervisor data card 57 via the inductive transmission system 42.

As another alternative, the attendant transponder 50 can operate as a passkey to release credits from an activity station 40. To place or re-place credits on the client transponder card 20, the attendant transponder 50 has a passkey in its memory unit 52. The activity station 40 recognizes the passkey as belonging to an attendant transponder 50. The attendant can collect money from the customer and then indicate how many credits to place on the client transponder card 20 by waving the attendant transponder 50 before the activity station 40 in range of the inductive transmission system 42. The client transponder card 20 is then placed in range of the inductive transmission system 42 of the activity station 40 so that the debit/credit event criterion can be written or re-written. Of course, the customer can always return to the management station 30 to purchase more credits or collect winnings, if any, as well. The activity station 40 maintains an accounting of the credits issued from it and communicates that data to the management station 30 in real time or periodically via the network data connection.

Another alternative is a two card configuration. A cash control and denomination card 56a is used to set the denomination and/or incremental increase for debits/credits. The card 56a is held before the inductive transmission system 42 of the activity station 40. The station 40 then indicates then increments or denominations of currency to be distributed. For example, the activity station can display “$1” then at a predetermined interval increase the amount displayed to “$5” then to “$10” and so on. Once the desired increment is reached, the card 56a is removed from the range of the inductive transmission system 42. This sets the increment. A client transponder 20 is then placed in range of the activity station 40 to acquire the debit/credit set by the card 56a. Each pass of the client transponder 20 adds (or deducts) the increment set by the card 56a. For example, a station 40 set to $10 increments by the cash control and denomination card 56a will add $10 to a client transponder 20 for each pass. The client transponder 20 then will have a total credit of $10 then $20 then $30 and so on for each pass within range of the inductive transmission system 42. The supervisor card 57 is still used as described above in this alternative configuration. Alternatively, a client transponder 20 can use a similar incremental approach to removing debits/credits from the transponder 20.

During game play or other idle times when the activity station 40 is not in active use, the management station 30 can collect data from the activity station 40 for the database and/or the automated redemption system software for management, security, and/or accounting purposes over the wireless network data connection between the management station transceiver 31 and the activity station transceiver 41. Data collected can include, but is not limited to, game score, debits and credits, user identity, user demographic information, and/or time usage.

Preferably, the activity station 40 can also notify the management station 30 of various events, event criteria, or the absence of activity. This notification can be used to trigger pre-determined events. For example, at random intervals or as prompted by reduced activity on a machine 100 as indicated by the activity station 40, the management station 30 can trigger a signal light 110 on the machine 100 indicating a period of a reduced operation price for that machine 100, e.g. 25 cents per play instead of one dollar per play. The management station 30 can also trigger signal lights 110 on a group of machines based on a total activity level indicated by the group. This feature can encourage game play on otherwise unused or under-used machines.

In addition to the above descriptions, the activity management system 10 can be used with a variety of activities, both coin-operated and not. Activity stations 40 can be placed at ticket booths of amusement park rides for ticketing purposes and to restrict access based on the variety of event criteria described above. The stations 40 can gather demographic and usage data about customers. The stations 40 can also be connected to turnstiles or gate apparatus to restrict access to an event, ride or facility. For example, a management station 30 can be placed at a ticketing counter of an amusement park. The management station 30 can issue client transponders 20 to customers. Preferably, the client transponders 20 store demographic data about the customers such as their age, sex, height, and size of the customer's group attending the park. The client transponders 20 can store debit and credit data and time stamps as described above. The client transponder 20 can also store an individualized marker for each customer.

Preferably, activity stations 40 are placed at each attraction at the amusement park such as rides, games and events. The activity station 40 can be integrated or connected to an access control device such as a gate or turnstile. This configuration can be used to control access to the attraction. A customer places the client transponder 20 within detection range of the activity station 40 so that the station 40 can read the memory unit of the transponder 20. The activity station 40 preferably has anti-collision detection protocols so that multiple client transponders 20, e.g. 50-60, can be detected and read simultaneously by the inductive transmission system 42. Moreover, an activity station 40 on a gate can use an inductive transmission system 42 with an extended detection range, e.g. 10-30 feet, to allow a number of client transponders 20 to pass through the gate proximately and/or simultaneously. This can improve the flow of customers into an attraction without losing counter of each individual's entrance.

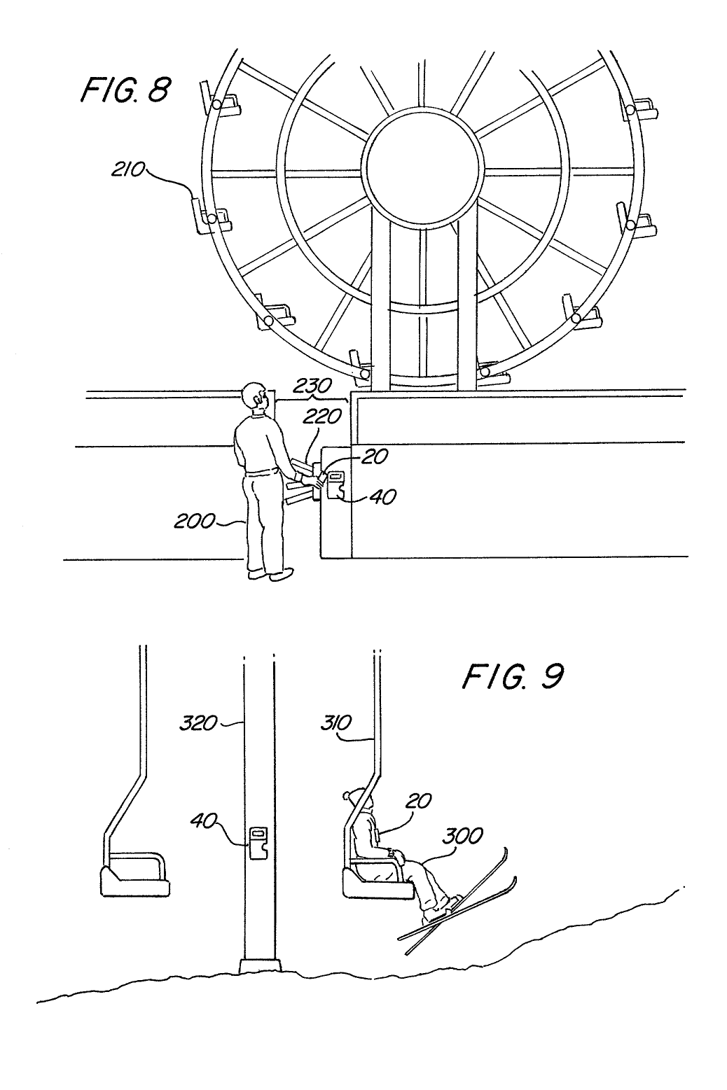

Referring to FIG. 8, a customer 200 is shown entering an attraction 210, a ferris wheel in this case, using a client transponder 20, preferably a card. The customer 200 passes the client transponder 20 within range of the activity station 40 and its inductive transmission system 42. If access is granted, the customer 200 can pass through the access control system 220, a turnstile here. Alternatively, as discussed above, the width 230 of the access control system 220 can be expanded to a wider gate. The range of the activity station 40 would be extended and anti-collision detection protocols can be used with the activity station 40 to allow more customers 200 to pass through the system at a time. The activity station 40 could also be placed above (or below) the access control system 220 focused on customers 200 passing beneath (above) the station 40.

Access can be granted or denied based on a variety of criteria. For example, access can be granted/denied based on demographic information, e.g. the customer's height, weight, and/or age. Access can be granted/denied based on available credits. Access can be granted/denied based on the time stamp on the client transponder 20.

Access can be granted/denied based upon a permitted ride indicator stored on the client transponder 20. The permitted ride group indicator is a predetermined set of rides that the customer is or is not allowed to access. For example, a parent or guardian at the management station 30 can pre-set the permitted ride group indicator on the client transponder 20 for the customer, typically a child. Thus, a parent can decide what rides or events their child may or may not access.

Additionally, the permitted ride group indicator can indicate a pre-selected group of rides established by the management of the facility. The closest example is a system previously employed by DISNEY® amusement parks. DISNEY® designated various groups of rides by letter codes (A, B, C, D, and E) and sold similarly coded tickets based on a ride's letter code, e.g. a small child's ride would be an “A” ticket while an older child or adult ride may be an “E” ticket. Only customers with “A” tickets could ride attractions or attend events in the “A” group. Only customers with “E” tickets could ride or attend “E” group rides or events. In the present invention, the permitted ride group indicator can indicate that a customer is only allowed access to one pre-determined group (or groups) of rides. Conversely, the permitted ride group indicator can indicate that a customer is denied access to one or more groups of rides. This system is superior to the coded ticket system as the customer does not need to repeatedly return to a ticket booth to purchase new coded tickets for different rides or repeated trips to the same ride. Instead, the customer carries the client transponder 20 with a permitted group indicator that need not expire after a set number of uses.

Access can also be granted based upon an appointment system. For example, using the time stamp data saved on the client transponder 20, an activity station 30 can grant or deny access to a customer. A schedule can be established for an attraction based upon the number of customers riding/attending an attraction. If a high volume of customers are riding/attending an attraction, customers waiting in line can be given an appointment to return at a future time. The appointment time can be saved on the client transponder 20. The appointment time can be distributed to customers by an activity station 40 or an attendant transponder 50. An activity station 40, using the time stamp data, can determine whether a customer's appointment time is at hand and, thereby, grant or deny access. This can reduce the wait time for customers for various popular attractions.

The system 10 can also be used to manage amusement park attractions and/or monitor the flow of customers at the park. Each activity station 40 reports the number of client transponders 20 (along with the other data present on the individual client transponders 20) that travel through the access control device, e.g. turnstile, to the management station 30. The management station 30 can monitor a variety of data regarding the event or ride including the number of customers riding at a given time. This data can assist amusement park personnel in making decisions regarding various attractions including the number of park personnel to place at a given attraction, opening additional attractions, and scheduling maintenance.

The amusement park can also use the system 10 to track individual customers. The individualized marker assigned to a client transponder 20 can be read and transmitted to the management station 30 from each activity station 40 attended by the customer. Park personnel can use this tracking data to follow the flow of customers from their entry to the park and throughout the customer's attendance at the park.

The system 10 can be used at ski resorts and in conjunction with ski lifts and ski runs. Just as with amusement park attractions, client transponders 20 can be encoded to control customer access to various ski resort facilities such as lifts and ski runs. Activity stations can be integrated with turnstiles, chair lifts and other access control systems. Customers can be granted or denied access to various ski resort facilities based upon, inter alia, age, height, or a skier ability rating read from the client transponders 20. Access can also be controlled using the time stamp.

A ski resort can use the system 10 to analyze demographic data to assist in managing the resort, lifts and runs like the amusement park described above. For example, ski runs and lifts can be opened and closed based on the number of customers using the slopes at a given time.

Referring to FIG. 9, a skier 300 is shown on a ski lift 310. The skier 300 shown wears a client transponder 20 on his person. Preferably, the client transponder 20 is contained within a lift ticket. To ascend a hill or mountain, the skier 300 sits on the ski lift 310. An activity station 40 is preferably mounted on a ski lift support 320. The inductive transmission system 42 of the activity station is calibrated to detect client transponders 20 as the transponders 20 pass the support 320. Thus, as discussed below, data can be collected from the transponders 20 and access to the lift and/or mountain can be granted or denied and monitored.

Alternatively, the activity station 40 can be positioned at the top of the ski lift 310 (usually at the top of the hill, mountain or ski run the lift 310 is climbing) and used, along with, for example, a skier ability rating read from the transponder 20, to determine access to one or more particular ski runs. For example, a novice skier could be directed to a ski run for novice skiers and away from a ski run for expert skiers.

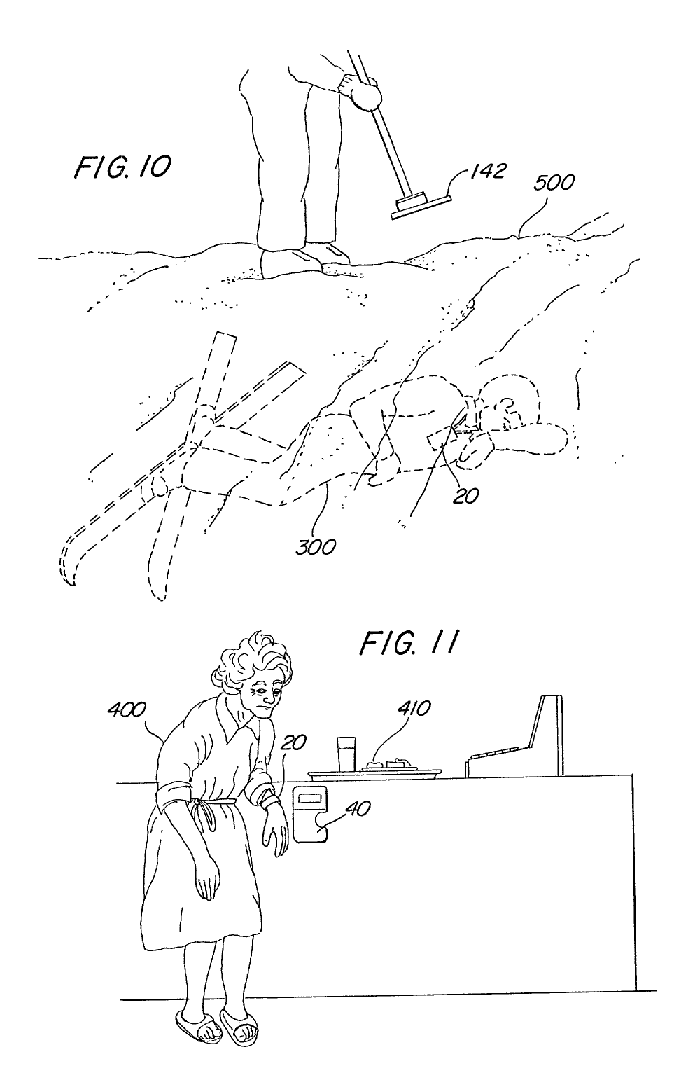

Referring to FIG. 10, the system 10 can also be used to locate individual persons. The individual marker described above can be used to track the slopes and lifts used by a skier 300, including the last slope or lift used. Furthermore, a skier 300, just as with a lift ticket, typically would attach the client transponder 20 to his or her apparel during skiing. If the skier were lost in an avalanche or otherwise obscured by snow and/or other material 500, a search for the skier's client transponder 20 can assist in locating the skier, e.g. using a portable inductive transmission system 142 like the inductive transmission system 42 used in the activity stations 40 described above. A portable inductive transmission system 142 preferably has an increased detection range for locating client transponders 20, e.g. 20-30 feet. The portable inductive transmission system 142 and/or a client transponder 20 could also be integrated with a global positioning system (GPS) to establish the approximate location of the client transponder 20. The portable transmission system 142 could also emit a range signal responsive to data received from the client transponder 20. For example, an audio signal could increase in frequency as the portable transmission system approached the client transponder 20. Thus, the system 10 can be used to locate missing persons.

The system 10 can be used for access control and/or debit/credit purposes in a variety of situations. Activity stations 40 can be placed on casino tables for non-coin operated gaming such as craps and blackjack to record bets and winnings. Activity stations 40 can be placed on vending machines to control the coin/cash mechanism and the dispensing of food and other items. The system 10 can also be used in conjunction with a subway system for access control and/or debit/credit purposes.

In general, activity stations 40 can be used in retail and commercial settings to control or reduce the use of cash and other methods of payment. For example, the system 10 can be used at a military base commissary or PX. Personnel can be issued client transponders 20 and have credits placed on client transponders 20, e.g. through direct deposit to an account from a paycheck. Personnel can then purchase items at the commissary using credits on the client transponder 20.

Referring now to FIG. 11, another alternative embodiment is shown. In a hospital, or other healthcare facility, patients can have credits put on client transponders 20 to purchase food 410 and other items at the hospital cafeteria or gift shop. However, criteria placed on the client transponders 20, such as patient dietary restrictions or needs, can bar or grant access to various items. For example, a patient with heart trouble would not be allowed to purchase a high cholesterol food item like a three-egg omelet or a diabetic patient would not be allowed to purchase an item with sugar at the hospital cafeteria. The system 10 can also control patient, employee or visitor access to various locations in the hospital. For example, visiting hours could be enforced through the time stamp criteria on client transponders 20 issued to visitors. Client transponders 20 can also store patient medical histories such as allergies, past medical treatments, and other medical information for quick and easy access by medical personnel. Preferably, a client transponder 20 for patients would be integrated with a standard patient bracelet.

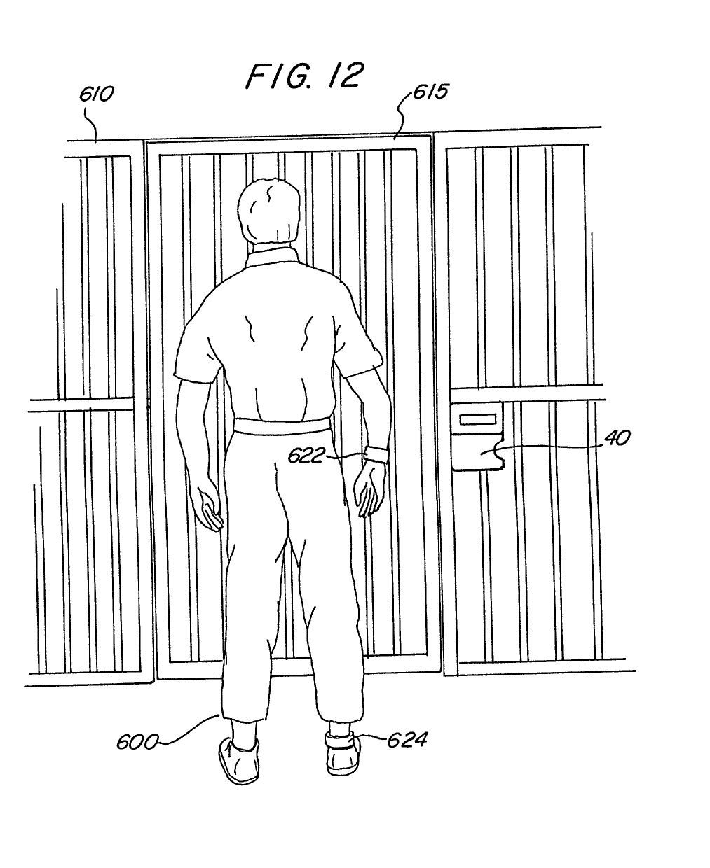

Referring now to FIG. 12, another embodiment of the system 10 is shown. The system 10 can be used at a jail or prison or other correctional facility 610. For example, an inmate 600 can be issued a client transponder 20. Preferably, an inmate's client transponder 20 would be integrated with or contained within a bracelet, anklet or other item that could not be easily removed by the inmate 600. A bracelet 622 and anklet 624 are shown in FIG. 12. Again, subcutaneous implantation of the client transponder 20 may be useful. Alternatively, the transponder 20 could alert authorities at the facility 610 that the client transponder 20 had been removed from the inmate's person 600.

The system 10, as described above, can be used to limit the use of cash and other monetary systems in the facility 610 by allowing the inmates 600 to receive debits/credits on the client transponder 20 limited to their personal use. Inmate purchases can also be limited on an individualized basis based on criteria stored on the client transponder 20. This can improve security at the facility 610 and reduce inmate theft and incidents stemming from theft.

The system 10, as described above, can also be used to control access to various areas in the facility 610. For example, inmates 600 could be allowed at the facility's exercise area during a specified time based on their cellblock. Individual inmates 600 could also be restricted/permitted in specified areas on an individual basis. For example, an inmate 600 could only pass through the door 615 of his/her own cell. Another example is that only an inmate 600 with an identified authorized visitor could gain access to a visitation room. These uses of the present invention can improve security at a correctional facility 610.

As described above with skiers and amusement park customers, the system 10 can be used to track the movement and/or location of inmates 600. The portable inductive transmission system 142, described above, could also be used to scan areas for hidden inmates 600.

In addition to the above descriptions and embodiments, the event criteria placed on client transponders 20 can be used in a variety of ways. A customer location criterion can be placed on the transponder 20 so that the transponder 20 cannot be used at another location with a similar activity management system 10. This reduces the chance of debits/credits being moved out of the accounting system and used improperly at a different location.

A customer identification criterion can be placed on the client transponder 20. Thus, customers can be given access (or restricted from access for “bad members,” e.g. members with delinquent accounts) to various machines and locations on an individual basis. This criterion or a separate club criterion can also be used to indicate a club membership. Club membership can be associated with member benefits such as bonus debits/credits, frequent play debits/credits, and/or prizes.

A gaming group criterion can be placed on the card 20. Thus, customers can be given access (or restricted from access) to various machines on a machine group basis. For example, in an arcade and coin-operated batting cages facility, a customer's client transponder 20 could be restricted for use only with the batting cages. Access to the arcade would be denied.

A password criterion can be placed on the card 20 as well. When the activity station 40 reads the password criterion, it can require a predetermined sequence of inputs to activate the machine 100 to which it is connected. For example, the password criterion may require a predetermined card wave combination in front of the inductive transmission system 42. Alternatively, a keypad may be installed on the station 40 to require an alphanumeric password to be entered for activation of the machine 100. Another alternative is to use a biometric key based on, inter alia, a customer's fingerprint.

The activity management system 10 allows for novel uses of previously known coin-operated machines. For example, as opposed to a slot machine or video poker machine, a video arcade machine typically does not issue winnings to a customer for successful game play. However, with the activity management system 10, credits/debits can be issued from the activity station 40 to a client transponder card 20 based on game score and redeemed for prizes and/or currency.

Thus, an activity management system is described above that facilitates the accounting, maintenance and security of coins, bills and/or other currency and that does not require the user to leave his or her machine to return to a central location to acquire tokens, coins, or change for bills. The activity management system also provides access control and information to management to improve security, control cash flow, improve system management and accounting, and improve system monitoring.

The activity management system described above gathers valuable data about customers' demographics and other information for marketing, management and other purposes. The system described also provides a variety of access control and management features for a variety of locations such as amusement parks, ski resorts, subways, hospitals and correctional facilities. In each of the above embodiments, the different positions and structures of the present invention are described separately in each of the embodiments. However, it is the full intention of the inventors of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An activity management system comprising:
a client transponder;
an activity station comprising an inductive transmission system, the activity station mounted an access control device; and, a management station having a network data connection with the activity station.

2. The activity management system of claim 1 where the access control device is a turnstile.

3. The activity management system of claim 1 where the access control device is a ticketing booth.

4. The activity management system of claim 1 where the access control device is a gate.

5. The activity management system of claim 1 where the activity station controls ingress through the access control device.

6. An activity management system comprising:
a client transponder having a memory unit;
an activity station comprising an inductive transmission system, the activity station integrated with an access control device and controlling ingress through the access control device; and, a management station having a network data connection with the activity station.

7. The activity management system of claim 6 where the memory unit contains access criteria.

8. The activity management system of claim 6 where the memory unit contains demographic data.

9. The activity management system of claim 6 where the memory unit contains a time stamp.

10. The activity management system of claim 6 where the memory unit contains a debit and credit indicator.

11. The activity management system of claim 6 where the memory unit contains a permitted ride group indicator.

12. The activity management system of claim 6 where the memory unit contains an appointment time.

13. The activity management system of claim 6 where the memory unit contains an individual marker.

14. The activity management system of claim 6 where the memory unit of the client transponder is readable by the inductive transmission system of the activity station; said activity station further having a station memory unit that stores the data from the client transponder and where the activity station transmits the data to the management station via the network data connection; the management station further comprising a computer for analyzing the data from the client transponder.

15. An activity management system comprising:
a client transponder having a memory unit containing criteria and data;
an activity station comprising an inductive transmission system for reading data and criteria from the memory unit of the client transponder, the activity station integrated with an access control device and controlling ingress through the access control device; and,
a management station having a computer for evaluating criteria and data received via a network data connection with the activity station.

16. The activity management system of claim 15 where the activity station further comprises a memory unit with programs for evaluating the criteria and data received from the memory unit of the client transponder.

17. The activity management system of claim 15 where the access control device is a turnstile.

18. The activity management system of claim 15 where the access control device is a gate.

19. The activity management system of claim 15 where the access control device is a ticket booth.

20. The activity management system of claim 15 where the access control device controls access to a ski lift.

21. The activity management system of claim 15 where the access control device controls access to an amusement park attraction.

22. The activity management system of claim 15 where the access control device controls access to a ski run.

23. A system for tracking a person comprising:
a client transponder with a memory unit, said memory unit containing an individual marker;
an activity station integrated with an access control system; said activity station having an inductive transmission system and a memory unit containing an access log;
a management station comprising a transceiver and a computer with a program for querying the access log of the activity station; where the management station has a network data connection with the activity station via the transceiver.

24. The system of claim 23 where the access log contains an access record of the client transponder as identified by the individual marker and a time stamp.

25. The system of claim 23 where the system further comprises a portable inductive transmission system for locating a client transponder.

26. The system of claim 25 where the portable inductive transmission system has a range signal responsive to data received from the client transponder.

27. The system of claim 25 where the portable inductive transmission system is integrated with a global-positioning satellite system.

28. The system of claim 23 where the access control device controls access to a ski lift.

29. The system of claim 23 where the access control device controls access to a ski run.

30. The system of claim 23 where the access control device controls access to an amusement park attraction.

31. An activity management system for a subway system comprising:
a client transponder having a memory unit;
an activity station comprising an inductive transmission system, the activity station integrated with an access control device; and
a management station having a computer with a network data connection to the activity station.

32. The system of claim 31 where the memory unit contains a debit and credit indicator.

33. The system of claim 31 where the access control device controls access to a subway terminal.

34. The system of claim 31 where the access control device is a gate.

35. The system of claim 31 where the access control device is a turnstile.

36. An activity management system for a correctional facility comprising:
a client transponder having a memory unit;
an activity station comprising an inductive transmission system for reading the memory unit of the client transponder, the activity station integrated with an access control device and containing an access log; and
a management station having a computer with a network data connection to the activity station.

37. The system of claim 36 where the access control device controls access to an area of the correctional facility.

38. The system of claim 36 where the memory unit contains an individual marker.

39. The system of claim 38 further comprising a portable inductive transmission system for locating the client transponder.

40. The system of claim 36 where the memory unit contains a time stamp.

41. The system of claim 40 where the access log contains a record of client transponder access including time stamps.

42. An activity management system for a hospital comprising:
a client transponder having a memory unit containing criteria;
an activity station comprising an inductive transmission system for reading the memory unit of the client transponder, the activity station integrated with an access control device and further comprising a memory unit with programs for evaluating the criteria received from the memory unit of the client transponder; and
a management station having a computer with a network data connection to the activity station.

43. The system of claim 42 where the access control device controls access to an area of the hospital.

44. The system of claim 42 where the activity station controls access to an area of the hospital according to a pre-determined time criteria.

45. The system of claim 42 where the criteria includes a dietary restriction.

46. The system of claim 42 where the memory unit further includes a medical history.

47. The system of claim 42 where the memory unit contains an individual marker.

48. The system of claim 47 further comprising a portable inductive transmission system for locating the client transponder.

49. An automated redemption system comprising
a client transponder;
an activity station comprising an inductive transmission system whereby the inductive transmission system encrypts data on the client transponder; and, a management station having a network data connection with the activity station.

50. An automated redemption system comprising
a client transponder;
an activity station comprising an inductive transmission system;
a management station having a network data connection with the activity station;
a plurality of attendant transponder cards including a cash control and denomination card where the activity station displays an increasing increment of credits at a predetermined time interval when the cash control and denomination card is in range of the inductive transmission system of the activity station; and, where credits are dispensed from the activity station to the client transponder when the client transponder is placed in range of the inductive transmission system based on the increment set when the sash control card is removed from range of the inductive transmission system.
